(19) United States
(12) Patent Application Publication
(10) Pub. No.: US 2020/0284227 A1
(43) Pub. Date: Sep. 10, 2020

(54) ENGINE WITH ELECTRIC COMPRESSOR BOOST AND DEDICATED EXHAUST GAS RECIRCULATION SYSTEM

(71) Applicant: GM Global Technology Operations LLC, Detroit, MI (US)

(72) Inventors: Edward J. Keating, Ortonville, MI (US); Prabjot Nanua, Ann Arbor, MI (US)

(21) Appl. No.: 16/291,571

(22) Filed: Mar. 4, 2019

(51) Int. Cl. F02M 26/04; F01N 5/04; F02D 29/02; F02D 29/06; F02B 37/14

(52) U.S. Cl. CPC F02M 26/04; F01N 5/04; F05D 2220/76; F02D 29/06; F02B 37/14; F02D 29/02

(57) ABSTRACT

An exhaust gas recirculation (EGR) system with independent intake air compressor includes an engine having at least one cylinder communicating with a cylinder exhaust passage. A bypass valve positioned in the cylinder exhaust passage when selectively aligned in a first position directs all exhaust from the at least one cylinder to an exhaust passage and when selectively aligned in a second position directs all exhaust from the at least one cylinder into an EGR dedicated passage. An intake manifold is in communication with the EGR dedicated passage. An electrically powered eBoost compressor when activated receives atmospheric air and generates a required boosted air pressure flow during a mid-load engine operation portion and a high-load engine operation portion for introduction into the intake manifold independently of the EGR dedicated passage. The eBoost compressor is deactivated during a low-load engine operation portion. A motor-generator generates at least a portion of the power for the eBoost compressor.

### INTRODUCTION

The present disclosure relates to vehicles with engines having boosted pressure air supply and exhaust gas recirculation systems.

Vehicles having turbocharged engines exhibit delayed torque response and cold start catalyst heating challenges. This leads to control strategy limitations to optimize fuel efficiency. Turbochargers also create engine pumping losses, engine oil degradation, and heat management challenges. The delayed torque response of a turbocharger due to time for the turbines to spin-up to full operating speed can be circumvented by the use of a low power, i.e., less than 8 kW eBooster, which may be powered by an available motor generator, and which more quickly reaches a desired boost pressure.

Low power eBoosters have been used in current vehicle designs to supplement turbochargers, however the air flow capability of low power eBoosters precludes total reliance on the low power eBooster and prevents maximizing fuel efficiency benefits that could be obtained by complete elimination of the turbocharger.

Conventional exhaust gas recirculation (EGR) systems create particular challenges when used in conjunction with an electrically powered boosted pressure air supply device. Conventional EGR systems designated as high pressure (HP) EGR systems are only capable of recirculating exhaust gas when exhaust pressure is greater than intake pressure, thereby preventing exhaust gas recirculation when manifold pressure exceeds exhaust pressure. Conventional EGR systems designated as low pressure (LP) EGR systems can supply EGR throughout an engine operating range but rely on the introduction of EGR prior to the boost pressure air supply device. The requirement that the boost pressure air supply device supply air plus EGR increases the power requirement of the device to meet a given engine power output. In addition, routing EGR through the boost pressure air device creates durability concerns including those related to heat and condensation. These concerns are more acute when the boost pressure air device is electrically powered compared to a conventional turbocharger.

Thus, while current vehicle EGR and turbocharging systems achieve their intended purpose, there is a need for a new and improved system and method for improving fuel consumption for engines with a boosted pressure air supply.

### SUMMARY

According to several aspects, an exhaust gas recirculation (EGR) system with independent booster includes an engine having at least one cylinder communicating with a cylinder exhaust passage. An EGR bypass valve positioned in the cylinder exhaust passage when selectively aligned in a first position directs all exhaust from the at least one cylinder to an exhaust manifold and when selectively aligned in a second position directs all exhaust from the at least one cylinder into an EGR dedicated passage. An intake manifold is in communication with the EGR dedicated passage. An electrically powered (eBoost) compressor when activated receives atmospheric air and generates a total boosted air pressure flow during a mid-load engine operation portion and a high-load engine operation portion for injection into the intake manifold independently of the EGR dedicated passage.

In another aspect of the present disclosure, an air inlet receives the atmospheric air; and a control valve is in communication with the air inlet.

In another aspect of the present disclosure, the control valve is open to direct the atmospheric air flow into an inlet passage and is closed to direct the atmospheric air into the eBoost compressor before entering the inlet passage.

In another aspect of the present disclosure, a charge air cooler is connected to the inlet header and is in communication with the intake manifold.

In another aspect of the present disclosure, an EGR cooler positioned between the EGR bypass valve and the intake manifold receives and cools exhaust gas discharged through the EGR bypass valve.

In another aspect of the present disclosure, an EGR mixer is positioned upstream of the intake manifold and is in direct communication with the EGR cooler and the charge air cooler.

In another aspect of the present disclosure, a bypass line leading to the eBoost compressor receives the atmospheric air when the control valve is closed and the eBoost compressor is activated; and a boosted pressure line receives the boosted air pressure flow from the eBoost compressor. The boosted pressure line bypasses the control valve and directs the boosted air pressure flow into the charge air cooler.

In another aspect of the present disclosure, the eBoost compressor is operated directly from a motor generator without electrical energy being received from a battery.

In another aspect of the present disclosure, a catalytic converter is directly connected to the exhaust header.

In another aspect of the present disclosure, the eBoost compressor is deactivated during a low-load engine operation portion.

According to several aspects, an exhaust gas recirculation (EGR) system with independent booster includes an engine having at least one cylinder communicating with a cylinder exhaust passage. A bypass valve is positioned in the cylinder exhaust passage, the bypass valve when selectively aligned in a first position directs all exhaust from the at least one cylinder to an exhaust passage and when selectively aligned in a second position directs all exhaust from the at least one cylinder into an EGR dedicated passage. An intake manifold is in communication with the EGR dedicated passage. An electrically powered eBoost compressor when activated receives atmospheric air and generates a required boosted air pressure flow during a mid-load engine operation portion and a high-load engine operation portion for introduction into the intake manifold independently of the EGR dedicated passage. The eBoost compressor is deactivated during a low-load engine operation portion. A motor-generator may generate an entire power for operating the eBoost compressor, or may generate at least a portion of a power for the eBoost compressor with the motor-generator assisted by an energy storage device such as a battery.

In another aspect of the present disclosure, the low-load engine operation portion occurs during vehicle driving conditions when boosted performance is not used.

In another aspect of the present disclosure, the mid-load engine operation portion occurs during vehicle driving conditions which use at least partial boosted performance, the mid-load engine operation portion defining a function of a change in an intake manifold pressure that is larger than an exhaust manifold pressure.

In another aspect of the present disclosure, the high load engine operation portion occurs during vehicle driving conditions up to a full boosted performance and an intake manifold pressure is controlled to achieve an engine power demand.

In another aspect of the present disclosure, the at least one cylinder communicating with the cylinder exhaust passage defines a dedicated EGR cylinder with the exhaust from the dedicated EGR cylinder entirely directed into the EGR dedicated passage and the intake manifold defining an EGR system operation.

In another aspect of the present disclosure, the engine includes four cylinders, with the at least one cylinder defining a single cylinder communicating with the cylinder exhaust passage.

In another aspect of the present disclosure, the engine includes eight cylinders, with the at least one cylinder defining up to two cylinders communicating with the cylinder exhaust passage.

According to several aspects, an exhaust gas recirculation (EGR) system with independent booster includes an engine having at least one cylinder communicating with a cylinder exhaust passage. An EGR bypass valve is positioned in the cylinder exhaust passage which when selectively aligned in a first position directs all exhaust gas from the at least one cylinder to an exhaust passage and when selectively aligned in a second position directs all exhaust gas from the at least one cylinder into an EGR dedicated passage. An intake manifold is in communication with the EGR dedicated passage. An electrically powered eBoost compressor when activated receives atmospheric air and generates a total boosted air pressure flow to the intake manifold independent of the EGR dedicated passage during a mid-load engine operation portion and a high-load engine operation portion. The eBoost compressor is deactivated during a low-load engine operation portion. A charge air cooler is positioned between the eBoost compressor and the intake manifold cooling the boosted air pressure flow prior to injection into the intake manifold. An EGR cooler positioned between the EGR bypass valve and the intake manifold cools the exhaust gas received in the EGR dedicated passage.

In another aspect of the present disclosure, an EGR mixer is positioned upstream of the intake manifold and in direct communication with the EGR cooler and the charge air cooler to receive the boosted air pressure flow and the exhaust gas.

In another aspect of the present disclosure, the boosted air pressure flow and the exhaust gas as a mixed flow exiting the EGR mixer enter an inlet line connected to the inlet air manifold and pass through and are controlled by a throttle positioned upstream of the inlet air manifold which throttles the flow of the boosted air pressure flow and the exhaust gas as the mixed flow before entering the inlet air manifold and to be distributed into the at least one cylinder of the engine.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of an EGR system with independent booster according to an exemplary aspect; and

FIG. 2 is a flow diagram of an algorithm controlling decisions of the EGR system with independent booster of FIG. 1.

### DETAILED DESCRIPTION

The following description is merely exemplary in nature and is not intended to limit the present disclosure, application, or uses.

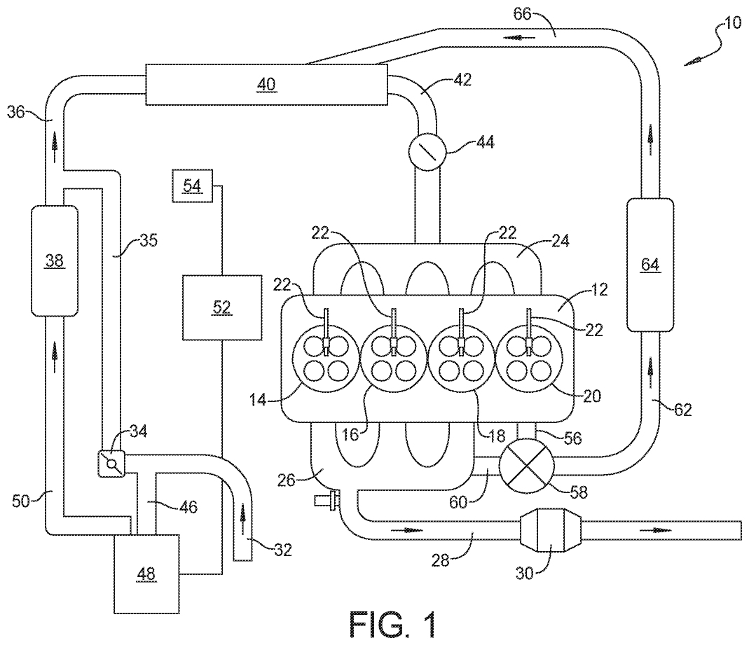

Referring to FIG. 1, a four-cylinder engine with an electric compressor boost and dedicated exhaust gas recirculation (EGR) system defines an EGR system with independent booster 10 having an engine 12, represented for example as a four-cylinder engine, which includes a first cylinder 14, a second cylinder 16, a third cylinder 18 and a fourth cylinder 20. The four-cylinder engine 12 is provided as an example. Six-cylinder and eight-cylinder engines can also be provided which benefit from the EGR system with independent booster 10 of the present disclosure. The engine 12 can be provided with direct injection fuel injectors 22. Combustion air is provided to the engine 12 via an inlet air manifold 24 and the engine exhaust is discharged into a collective exhaust manifold 26. An exhaust header 28 is directly connected to the exhaust manifold 26 and leads directly to an exhaust emission aftertreatment device 30 which may include a catalytic converter. There is no turbocharger in the EGR system with independent booster 10, therefore an exhaust gas discharged from the exhaust manifold 26 is directly discharged through the exhaust header 28 into the exhaust emission aftertreatment device 30, without generation of an exhaust backpressure on the engine 12 normally associated with a turbocharger.

During, non-boosted inlet air pressure operation of the engine 12, atmospheric air enters through an air inlet 32 and passes through a control valve 34, which may for example be a butterfly valve. The control valve 34 is normally open which directs air flow from the control valve 34 via a connecting line 35 directly into an inlet passage 36. The connecting line 35 bypasses atmospheric air around a charge air cooler 38. The inlet passage 36 is connected to an exhaust gas recirculation (EGR) mixer 40. Air and gases exiting the EGR mixer 40 enter an inlet line 42 connected to the inlet air manifold 24 and pass through and are controlled by a throttle 44 positioned upstream of the inlet air manifold 24 which throttles the flow of the air and gases before entering the inlet air manifold 24 and being distributed into each of the cylinders of the engine 12.

When the vehicle operator opens the throttle 44 quickly to a large open position, for example greater than 50%, indicating a high engine power operation is requested, for example during a passing operation, a hill-climbing operation, a highway entrance operation, or the like, additional inlet air boost pressure is used to rapidly meet the engine power output requirements. During this condition, the control valve 34 is closed which forces inlet air from the air inlet 32 into a bypass line 46 and into an electrically driven intake air compressor, or eBoost compressor 48, which when activated generates a required boosted air pressure and discharges a boosted air pressure flow through a boosted pressure passage 50 bypassing the control valve 34 and directly entering the charge air cooler 38. According to several aspects the charge air cooler 38 cools boosted air flow received from the eBoost compressor 48. The cooled air discharged from the charge air cooler 38 is directed into the inlet passage 36 and through the exhaust gas recirculation (EGR) mixer 40.

According to several aspects, the eBoost compressor 48 is a high-power compressor, defined as a compressor of greater than or equal to 8 kW power rating and according to several aspects greater than or equal to 12 kW power rating. A motor-generator 52 operated using engine rotational power provides the at least 8 kW and according to several aspects greater than or equal to 12 kW power to the eBoost compressor 48. The motor-generator 52 provides charging power for an energy storage system 54 such as a battery or a battery pack. The eBoost compressor 48 may be operated directly from the motor-generator 52 without drawing any electrical power from the energy storage system 54 or may draw a portion of power from the energy storage system 54. A boost pressure provided from an eBoost compressor of greater than 8 kW power rating is sufficient to obviate the need for a turbocharger in certain vehicle applications equipped with small displacement engines. A boost pressure provided from an eBoost compressor of up to 12 kW power rating is sufficient to obviate the need for a turbocharger in other vehicle applications equipped with large displacement engines.

Fuel economy is further enhanced using exhaust gas recirculation (EGR) features. At least one of the cylinders is predesignated as a dedicated EGR cylinder, which according to several aspects may be the fourth cylinder 20. Instead of being directly discharged into the exhaust manifold 26, exhaust output from the fourth cylinder 20 flows through a dedicated cylinder exhaust passage 56. A dual-position EGR bypass valve 58 is connected to the dedicated cylinder exhaust passage 56. For non-EGR engine operation, the EGR bypass valve 58 is positioned in a first position to direct all exhaust output from the fourth cylinder 20 into a connecting line 60 which then exhausts directly into the exhaust manifold 26.

When EGR flow is desired, the EGR bypass valve 58 is positioned in a second position which directs all exhaust flow out of the EGR dedicated cylinder, which according to several aspects is the fourth cylinder 20, into the dedicated cylinder exhaust passage 56 and through an EGR loop. The EGR loop includes an EGR dedicated passage 62 connected to the EGR bypass valve 58. The EGR dedicated passage 62 connects to and directs exhaust flow into an EGR cooler 64 which cools the exhaust gases output from the EGR dedicated cylinder. The piston of the EGR dedicated cylinder such as the fourth cylinder 20 acts as a positive displacement pump to circulate exhaust gas output from the EGR dedicated cylinder toward the inlet air manifold 24 under all potential operating conditions without assistance from the eBoost compressor 48. From the EGR cooler 64, the cooled exhaust from the EGR dedicated cylinder such as the fourth cylinder 20 flows through a mixing input passage 66. The mixing input line 66 feeds cooled exhaust gases into the EGR mixer 40 which mixes the cooled exhaust gases with the air received from the inlet passage 36 prior to introduction into the inlet air manifold 24.

When elevated engine power is demanded EGR flow can also be used in combination with boosted pressure flow from the eBoost compressor 48. As previously noted the control valve 34 is closed and the eBoost compressor 48 is energized. Air flow from the air inlet 32 flows into the eBoost compressor 48 and from the eBoost compressor 48 discharges into the inlet passage 36 and through the charge air cooler 38 into the EGR mixer 40.

One benefit of the eBoost compressor 48 is that the eBoost compressor 48 may operate using full available power from the motor-generator 52, without drawing power from a vehicle energy storage device such as a battery or battery pack to power the eBoost compressor 48. A second benefit of the eBoost compressor 48 is its ability to spin-up to full power speed typically in less than a half second, where a comparable turbocharger may take approximately two seconds to two and a half seconds to achieve full boost speed, thereby inducing turbocharger delayed torque response. A further benefit of the eBoost compressor 48 is that boost pressure provided from the eBoost compressor of greater than 8 kW power rating does not impede EGR operation when pressurized exhaust flow from the fourth cylinder 20 is also entering the EGR mixer 40.

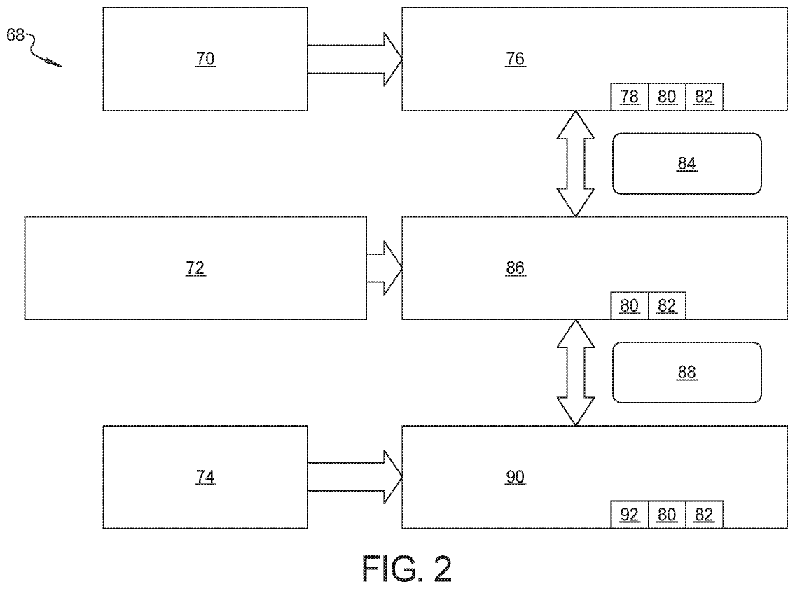

Referring to FIG. 2 and again to FIG. 1, an algorithm 68 controls decisions of the engine incorporating the specific EGR system with independent booster 10 such as when to operate the EGR loop by changing the position of the EGR bypass valve 58, and when to operate the eBoost compressor 48 together with closing the control valve 34. The EGR system with independent booster 10 may divide the algorithm 68 into three vehicle load engine operation portions, including a low-load engine operation portion 70, a mid-load engine operation portion 72, and a high load engine operation portion 74.

The low-load engine operation portion 70 occurs during vehicle driving conditions when boosted performance is not required, therefore the eBoost compressor 48 is deactivated (OFF). During the low-load engine operation portion 70 in an algorithm portion 76 engine load is achieved for best efficiency as a function of throttle position 78, an intake cam shaft position 80, an exhaust cam shaft position 82, and with the EGR loop portion of the system activated or deactivated. A transition stage 84 between the low-load engine operation portion 70 to the mid-load engine operation portion 72 occurs as a best efficiency dictates.

The mid-load engine operation portion 72 occurs when at least partial boosted performance is desirable and therefore the eBoost compressor 48 is activated. The mid-load engine operation portion 72 is enabled as the throttle 44 approaches a full open position to meet required power. An intake manifold pressure may be specified using the eBoost compressor that is slightly higher than the exhaust manifold pressure. This pressure differential allows intake pressure to more fully expel burned exhaust gases from the previous engine cycle when combined with intake and exhaust valve overlap enabling improved efficiency. During the mid-load engine operation portion 72 in an algorithm portion 86 engine load is achieved for best efficiency as a function of the intake cam shaft position 80, the exhaust cam shaft position 82, and with the EGR loop portion of the system activated or deactivated. A transition stage 88 between the mid-load engine operation portion 72 to the high load engine operation portion 74 occurs as a best efficiency dictates.

The high load engine operation portion 74 occurs during vehicle driving conditions when high boosted performance is required and therefore the eBoost compressor 48 is activated. An intake manifold pressure is controlled to achieve the engine power demand. During the high load engine operation portion 74 in an algorithm portion 90 engine load is achieved for best efficiency as a function of an intake manifold pressure 92, the intake cam shaft position 80, the exhaust cam shaft position 82, and with the EGR loop portion of the system activated or deactivated.

An EGR system with independent booster 10 of the present disclosure offers several advantages. The present system replaces a turbocharger with a high power (>=8 kW) eBooster along with use of cooled dedicated EGR and an enhanced control strategy to enable improved fuel economy when applied to an appropriate vehicle. The high power, >=8 kW and according to several aspects>=12 kW electrically driven compressor (eBoost compressor 48) may be used in engines equipped with an appropriately sized motor-generator. The system of the present disclosure provides fast engine torque response, improved cold start catalyst heating and reduced pumping losses, which enable improved fuel economy and lower exhaust emissions. The cooled dedicated EGR unit further enhances fuel consumption benefits without negatively impacting the performance or durability of the eBoost compressor 48.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An exhaust gas recirculation (EGR) system with independent intake air compressor, comprising:
an engine having at least one cylinder communicating with a cylinder exhaust passage;
an EGR bypass valve positioned in the cylinder exhaust passage when selectively aligned in a first position directing all exhaust gas from the at least one cylinder to an exhaust passage and when selectively aligned in a second position directing all exhaust gas from the at least one cylinder into an EGR dedicated passage;
an intake manifold in communication with the EGR dedicated passage; and
an electrically powered eBoost compressor when activated receiving atmospheric air and generating a required boosted air pressure flow during a mid-load engine operation portion and a high-load engine operation portion for introduction into the intake manifold independently of the EGR dedicated passage.

2. The exhaust gas recirculation (EGR) system with independent intake air compressor of claim 1, further including:
an air inlet receiving the atmospheric air; and
a control valve in communication with the air inlet.

3. The exhaust gas recirculation (EGR) system with independent intake air compressor of claim 2, wherein the control valve is open to direct the atmospheric air into an inlet passage and is closed to direct the atmospheric air into the eBoost compressor before entering the inlet passage.

4. The exhaust gas recirculation (EGR) system with independent intake air compressor of claim 3, further including a charge air cooler connected to the eBoost compressor and the inlet passage.

5. The exhaust gas recirculation (EGR) system with independent intake air compressor of claim 4, further including an EGR cooler positioned between the bypass valve and the intake manifold receiving and cooling the exhaust gas discharged through the bypass valve.

6. The exhaust gas recirculation (EGR) system with independent intake air compressor of claim 5, further including an EGR mixer positioned upstream of the intake manifold and in direct communication with the EGR cooler and the inlet passage.

7. The exhaust gas recirculation (EGR) system with independent intake air compressor of claim 3, further including:
a connecting line connecting the control valve to the inlet passage; and
a boosted pressure passage receiving the boosted air pressure flow from the eBoost compressor, the boosted pressure passage bypassing the control valve and directing the boosted air pressure flow into the inlet passage.

8. The exhaust gas recirculation (EGR) system with independent intake air compressor of claim 1, wherein the eBoost compressor is operated directly from a motor generator without electrical energy being received from an energy storage system including a battery.

9. The exhaust gas recirculation (EGR) system with independent intake air compressor of claim 1, wherein the eBoost compressor is operated from a motor generator with additional electrical energy being received from an energy storage system including a battery.

10. The exhaust gas recirculation (EGR) system with independent intake air compressor of claim 1, wherein the eBoost compressor is deactivated during a low-load engine operation portion.

11. An exhaust gas recirculation (EGR) system with independent intake air compressor, comprising:
an engine having at least one cylinder communicating with a cylinder exhaust passage;
a bypass valve positioned in the cylinder exhaust passage when selectively aligned in a first position directing all exhaust from the at least one cylinder to an exhaust passage and when selectively aligned in a second position directing all exhaust from the at least one cylinder into an EGR dedicated passage;
an intake manifold in communication with the EGR dedicated passage;
an electrically powered eBoost compressor when activated receiving atmospheric air and generating a total boosted air pressure flow during a mid-load engine operation portion and a high-load engine operation portion for introduction into the intake manifold independently of the EGR dedicated passage, the eBoost compressor being deactivated during a low-load engine operation portion; and
a motor-generator generating at least a portion of an operating power for the eBoost compressor.

12. The exhaust gas recirculation (EGR) system with independent intake air compressor of claim 11, wherein the low-load engine operation portion occurs during vehicle driving conditions when boosted performance is not required.

13. The exhaust gas recirculation (EGR) system with independent intake air compressor of claim 11, wherein the mid-load engine operation portion occurs during vehicle driving conditions which require at least partial boosted performance, the mid-load engine operation portion defining a function of a specifying an intake manifold pressure higher than an exhaust manifold pressure.

14. The exhaust gas recirculation (EGR) system with independent intake air compressor of claim 11, wherein the high-load engine operation portion occurs during vehicle driving conditions which require high boosted performance and an intake manifold pressure is controlled to achieve an engine power demand.

15. The exhaust gas recirculation (EGR) system with independent intake air compressor of claim 11, wherein the at least one cylinder communicating with the cylinder exhaust passage defines a dedicated EGR cylinder with the exhaust from the dedicated EGR cylinder entirely directed into the EGR dedicated passage and the intake manifold defining an EGR system operation.

16. The exhaust gas recirculation (EGR) system with independent intake air compressor of claim 11, wherein the engine includes four cylinders, with the at least one cylinder defining a single cylinder communicating with the cylinder exhaust passage.

17. The exhaust gas recirculation (EGR) system with independent intake air compressor of claim 11, wherein the engine includes eight cylinders, with the at least one cylinder defining up to two cylinders communicating with the cylinder exhaust passage.

18. An exhaust gas recirculation (EGR) system with independent intake air compressor, comprising:
an engine having at least one cylinder communicating with a cylinder exhaust passage;
a bypass valve positioned in the cylinder exhaust passage when selectively aligned in a first position directing all exhaust gas from the at least one cylinder to an exhaust passage and when selectively aligned in a second position directing all exhaust gas from the at least one cylinder into an EGR dedicated passage;
an intake manifold in communication with the EGR dedicated passage;
an electrically powered eBoost compressor when activated receiving atmospheric air and generating a total boosted air pressure flow to the intake manifold independent of the EGR dedicated passage during a mid-load engine operation portion and a high-load engine operation portion, the eBoost compressor being deactivated during a low-load engine operation portion;
a charge air cooler positioned between the eBoost compressor and the intake manifold cooling the boosted air pressure flow prior to introduction into the intake manifold; and
an EGR cooler positioned between the bypass valve and the intake manifold cooling the exhaust gas received in the EGR dedicated passage.

19. The exhaust gas recirculation (EGR) system with independent intake air compressor of claim 18, further including an EGR mixer positioned upstream of the intake manifold and in direct communication with the EGR cooler and the charge air cooler to receive the boosted air pressure flow and the exhaust gas.

20. The exhaust gas recirculation (EGR) system with independent intake air compressor of claim 19, wherein one of a boosted and a non-boosted air pressure flow and the exhaust gas exiting the EGR mixer as a mixed flow enter an inlet passage connected to the intake manifold and pass through and are controlled by a throttle positioned upstream of the intake manifold which controls flow of the mixed flow before entering the intake manifold to be distributed into the at least one cylinder of the engine.
